(19) United States
(12) Patent Application Publication
(10) Pub. No.: US 2026/0131704 A1
(43) Pub. Date: May 14, 2026

(54) VEHICLE SEATBACK LOCKING DEVICE

(71) Applicants: HYUNDAI MOTOR COMPANY, Seoul (KR); KIA CORPORATION, Seoul (KR); DAEWON PRECISION INDUSTRIAL CO., LTD, Ansan-si (KR)

(72) Inventors: Seung Chan Choe, Hwaseong-si (KR); Yeong Hoon Seo, Hwaseong-si (KR); Hyo Cheol Kang, Hwaseong-si (KR); Jung Sang You, Hwaseong-si (KR); Hong Sik Chang, Hwaseong-si (KR); Dong Il Lee, Ansan-si (KR); Jae Won Sim, Hwaseong-si (KR); Yun Ho Shin, Cheonan-si (KR); Deok Jin Yoo, Ansan-si (KR)

(73) Assignees: HYUNDAI MOTOR COMPANY, Seoul (KR); KIA CORPORATION, Seoul (KR); DAEWON PRECISION INDUSTRIAL CO., LTD, Ansan-si (KR)

(21) Appl. No.: 19/015,120

(22) Filed: Jan. 9, 2025

(30) Foreign Application Priority Data
Nov. 13, 2024 (KR) 10-2024-0160683

(51) Int. Cl. B60N 2/22; B60N 2/90

(52) U.S. Cl. CPC B60N 2/2245; B60N 2/933; B60N 2002/971

(57) ABSTRACT

A vehicle seatback locking device is configured to lock a striker using an upper latch and a lower latch, to lock, using a cam, the lower latch configured to lock the striker, and to prevent the lower latch from being rotated by external force in the unlocking direction. The locking device makes it possible not only to prevent the striker from being unlocked from the lower latch, but also to prevent unexpected movement of a seatback due to unlocking between the striker and the lower latch.

### CROSS-REFERENCE TO RELATED APPLICATION

This application claims, under 35 U.S.C. § 119(a), the benefit of and priority to Korean Patent Application No. 10-2024-0160683, filed on Nov. 13, 2024, the entire contents of which are incorporated herein by reference.

### BACKGROUND

### (a) Technical Field

The present disclosure relates to a vehicle seatback locking device, and more particularly, to a vehicle seatback locking device configured to lock a seatback to a striker provided in a vehicle body or unlock the seatback from the striker.

### (b) Background Art

In general, commercial vehicles, such as vans and pickup trucks with cargo compartments, have seats including a driver's seat and a passenger seat that are installed only in a first row. In some commercial vehicles, a rear seat may be further installed in a second row, in addition to the seats installed in the first row.

The rear seat is divided into a first seat called a side seat and a second seat called a center seat. Here, the first seat and the second seat are manufactured in a size ratio of approximately 6:4.

A conventional seatback locking device is described with reference to FIGS. 1 and 2. A seat cushion 12 of a rear seat 10 may be mounted on a rail 20 mounted on a floor panel so as to be slidably movable forward and rearward in order to adjust the seat to the desired seating position of a user.

In addition, a seatback 14 of the rear seat 10 is connected to the seat cushion 12 so as to be movable forward and rearward. Here, the seatback 14 of the rear seat 10 is connected to the seat cushion 12 so as to be foldable in order to secure a luggage space in a vehicle.

A rotary latch 30 having a freely rotatable structure is mounted on the back surface of the seatback 14. A striker 40 lockably coupled to the latch 30 is mounted on a body panel 50, i.e., a partition panel configured to partition a vehicle space into an interior space and a luggage space.

In practice, the above-mentioned rotary latch 30 is mounted on a seatback frame 16, which is the internal skeleton of the seatback 14.

In this case, the striker 40 is locked and inserted into the latch 30 at the unfolded position of the seatback 14, thereby maintaining a fixed state of the seatback 14, i.e., a locked state of the seatback in a state in which the seatback is unfolded.

In this state, when the seat cushion 12 of the rear seat 10 slides forward along the rail 20 in a state in which the seatback 14 is locked at the unfolded position, the seatback 14 connected to the seat cushion 12 is moved rearward by a predetermined angle, thereby implementing a relaxation/comfort mode to enable an occupant to take a relaxed, comfortable posture.

In this case, even if the seatback 14 is reclined, as shown in FIG. 2, the latch 30 is rotated to continuously lock the striker 40 so as to constantly maintain the locked state of the latch 30 with respect to the striker 40. Accordingly, the fixed state of the seatback 14 may be continuously maintained at the unfolded position.

As a configuration through which the locked state of the seatback 14 is released, i.e., as a configuration through which the striker 40 is released from the latch 30, a cable (not shown) pulled by operation of a lever (not shown) may be connected to the latch 30.

Accordingly, when a user pulls the lever such that the cable is pulled, the latch 30 is rotated in an unlocking direction. In this manner, the striker 40 may be separated from the latch 30, and the locked state of the seatback 14 is released.

In addition, in a state in which the locked state of the seatback 14 is released as described above, the user may fold the seatback 14 over the seat cushion 12. Accordingly, the upper space of the folded seatback 14 may be secured as a luggage space.

However, the above-described conventional seatback locking device has the following problems.

First, the latch 30 may be easily rotated in the unlocking direction by external force in the event of vehicle collision, causing the striker 40 to be easily unlocked from the latch 30. Accordingly, when the striker 40 is unlocked from the latch 30, the seatback 14 is released from the locked state thereof and, as such, the unfolded position of the seatback 14 is unexpectedly changed.

Second, in the event of vehicle collision, the striker 40 is unlocked from the latch 30 such that the seatback 14 becomes movable and the unfolded position of the seatback 14 is changed. In this case, the seatback 14 may deviate from the unfolded position and may move rearward, which may cause injury to an occupant sitting on the rear seat.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with the prior art. It is an object of the present disclosure to provide a vehicle seatback locking device configured to lock a striker using an upper latch and a lower latch, to lock, using a cam, the lower latch configured to lock the striker, and to fundamentally prevent the lower latch from being rotated by external force in the unlocking direction. It is thereby made possible not only to prevent the striker from being unlocked from the lower latch, but also to prevent unexpected movement of the seatback due to unlocking between the striker and the lower latch.

In one aspect, the present disclosure provides a vehicle seatback locking device including a seatback frame and a base bracket mounted on the seatback frame. The locking device also includes an upper latch having a sub-locking groove formed in a rear portion thereof. The upper latch is rotatably mounted on the base bracket by a first rotation shaft. The locking device further includes a first spring configured and arranged to connect the base bracket to the upper latch in a tensile manner. The locking device also includes a lower latch having a main locking groove formed in a rear portion thereof. The lower latch is rotatably mounted on the upper latch by a second rotation shaft. The locking device further includes a cam rotatably mounted on the first rotation shaft and a cable connected to an upper portion of the cam in a pullable manner. The locking device also includes a second spring configured to connect the lower latch to the cam in a tensile manner. The locking device further includes a striker fixedly mounted on a body panel. The striker is detachably locked and inserted into the sub-locking groove of the upper latch and the main locking groove of the lower latch.

In an embodiment, the lower latch may have a first locking groove formed in a front end thereof and a first locking protrusion formed on the front end thereof. The cam may have a second locking groove formed in a lower portion thereof and a second locking protrusion formed on the lower portion thereof. The second locking groove may have the first locking protrusion detachably inserted thereinto and may have the second locking protrusion detachably inserted into the first locking groove.

In another embodiment, the upper latch may have a first rotation shaft coupling hole formed in a front end thereof, and the cam may have a first rotation shaft coupling hole formed in a rear end thereof. The first rotation shaft may be inserted into and coupled to the respective first rotation shaft coupling holes.

In still another embodiment, the upper latch may be formed of a first upper latch and a second upper latch each having an identical shape. The first upper latch and the second upper latch may be coupled to each other with the lower latch interposed therebetween.

In yet another embodiment, the upper latch may have a slide end integrally formed to protrude from a rear end thereof. The slide end may have a first inclined surface formed at a rear portion thereof and configured to slidably contact the striker such that the striker is guided to and inserted into the sub-locking groove and the main locking groove.

In still yet another embodiment, the sub-locking groove of the upper latch may have a rubber damper mounted thereon. The rubber damper may be configured to reduce impact generated when the striker is inserted into the sub-locking groove.

In a further embodiment, the base bracket may have a spring fixing end formed on an upper portion thereof. The spring fixing end may be connected to an upper end of the first spring and the upper latch may have a fixing pin mounted in an upper end thereof. The fixing pin may be connected to a lower end of the first spring.

In another further embodiment, the upper latch may have a second rotation shaft coupling hole formed in a lower end thereof and the lower latch may have a second rotation shaft coupling hole formed therein and located at a position between the main locking groove and the locking protrusion. The second rotation shaft may be inserted into and coupled to the respective second rotation shaft coupling holes.

In still another further embodiment, the lower latch may have a hook portion formed to protrude upward from a rear end thereof and located at a rear side of the main locking groove. The hook portion may be configured to prevent the striker from being separated from the lower latch.

In yet another further embodiment, the lower latch may have a slide pin integrally formed at an upper portion of a rear end thereof. The slide pin may have a second inclined surface formed on a rear portion thereof and configured to slidably contact the striker such that the striker is guided to and inserted into the main locking groove.

In still yet another further embodiment, in a state in which the striker is locked and inserted into the sub-locking groove of the upper latch and the main locking groove of the lower latch, when the cam is rotated in an unlocking direction by pulling operation of the cable, the second spring may be tensioned. Simultaneously, the second locking protrusion of the cam may be separated from the first locking groove of the lower latch, and then the lower latch may also be rotated in the unlocking direction by elastic restoring force of the second spring such that the first locking protrusion of the lower latch is locked and inserted into the second locking groove of the cam.

In a still further embodiment, the lower latch may be rotated in the unlocking direction by the elastic restoring force of the second spring such that the main locking groove of the lower latch is located at an open position allowing the striker to be separated from the main locking groove.

In a yet still further embodiment, in a state in which the seatback is folded such that the striker is separated from the sub-locking groove of the upper latch and the main locking groove of the lower latch, when the seatback is unfolded again, the striker may be guided to the sub-locking groove and the main locking groove while slidably contacting a slide pin formed on the lower latch.

In another embodiment, when the striker is guided by the slide pin of the lower latch so as to be inserted into the main locking groove such that the lower latch is rotated in a locking direction by force pushing the slide pin of the lower latch, the second spring may be tensioned. Simultaneously, the first locking protrusion of the lower latch may be separated from the second locking groove of the cam, and then the cam may also be rotated in the locking direction by the elastic restoring force of the second spring such that the second locking protrusion of the cam is locked and inserted into the first locking groove of the lower latch.

In still another embodiment, in a state in which the rear seat is slidably moved forward and then the seatback is folded such that the striker is separated from the sub-locking groove of the upper latch and the main locking groove of the lower latch, when the seatback is unfolded again, the striker may be guided to the sub-locking groove and the main locking groove while sequentially slidably contacting a slide end formed on the upper latch and a slide pin formed on the lower latch.

In yet another embodiment, in a state in which the seatback is reclined by forward sliding movement of the rear seat such that the striker is located higher than the upper latch and the lower latch, when the seatback is unfolded again, the slide end formed on the upper latch and the slide pin formed on the lower latch may be sequentially pushed by the striker and may be rotated forward by a predetermined angle.

In still yet another embodiment, when the striker is guided by the slide end of the upper latch so as to be inserted into the main locking groove such that the lower latch is rotated in a locking direction by force pushing the slide pin of the lower latch, the second spring may be tensioned. Simultaneously, the first locking protrusion of the lower latch may be separated from the second locking groove of the cam, and then the cam may also be rotated in the locking direction by elastic restoring force of the second spring such that the second locking protrusion of the cam is locked and inserted into the first locking groove of the lower latch.

In a further embodiment, the upper latch may be further rotated by a predetermined angle in the locking direction by pushing force of the striker. Simultaneously, the cam and the lower latch may also be further rotated by the same predetermined angle in the locking direction, thereby allowing a hook portion of the lower latch to be located at a position preventing separation of the striker inserted into the sub-locking groove of the upper latch and the main locking groove of the lower latch.

In another further embodiment, the cam may have a first fixing pin mounted in an upper end thereof and configured to allow an upper end of the second spring to be connected thereto. The lower latch may have a second fixing pin mounted in a lower portion of a front end thereof and configured to allow a lower end of the second spring to be connected thereto.

In still another further embodiment, the first fixing pin may have a cable holder mounted thereon. The cable holder may have the cable connected thereto in a pullable manner.

Other aspects and embodiments of the disclosure are discussed herein.

It should be understood that the terms “vehicle”, “vehicular”, and other similar terms as used herein are inclusive of motor vehicles in general. Such motor vehicles may encompass passenger automobiles including sport utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure will now be described in detail with reference to certain example embodiments thereof illustrated in the accompanying drawings which are given hereinbelow by way of illustration only, and thus are not limitative of the present disclosure, and wherein:

FIGS. 1 and 2 are schematic views each showing a conventional vehicle seatback locking device and the operation thereof;

FIG. 3 is an exploded perspective view of a vehicle seatback locking device according to the present disclosure;

FIG. 4 is an assembled perspective view of a vehicle seatback locking device according to the present disclosure;

FIG. 5 is a side view and a side cross-sectional view of a mounting state of a vehicle seatback locking device according to the present disclosure, in which the side cross-sectional view shows a locking arrangement state of the vehicle seatback locking device at a position before forward sliding movement of a seat;

FIGS. 6A-6C are side cross-sectional views of a vehicle seatback locking device according to the present disclosure, in which the side cross-sectional views sequentially show the operation of unlocking the vehicle seatback locking device from a locked state of the vehicle seatback locking device at a position before forward sliding movement of the seat;

FIGS. 7A-7C are side cross-sectional views of the vehicle seatback locking device according to the present disclosure, in which the side cross-sectional views sequentially show the operation of locking the vehicle seatback locking device from an unlocked state of the vehicle seatback locking device at a position before forward sliding movement of the seat;

FIG. 8 is a side cross-sectional view showing the seatback mounting state of a vehicle seatback locking device according to the present disclosure, in which the side cross-sectional view shows a locking arrangement state of the vehicle seatback locking device at a position after forward sliding movement of the seat;

FIGS. 9A-9C are side cross-sectional views of a vehicle seatback locking device according to the present disclosure, in which the side cross-sectional views sequentially show the operation of unlocking the vehicle seatback locking device from a locked state of the vehicle seatback locking device at a position after forward sliding movement of the seat; and

FIGS. 10A-10C are side cross-sectional views of a vehicle seatback locking device according to the present disclosure, in which the side cross-sectional views sequentially show the operation of locking the vehicle seatback locking device from an unlocked state of the vehicle seatback locking device at a position after forward sliding movement of the seat.

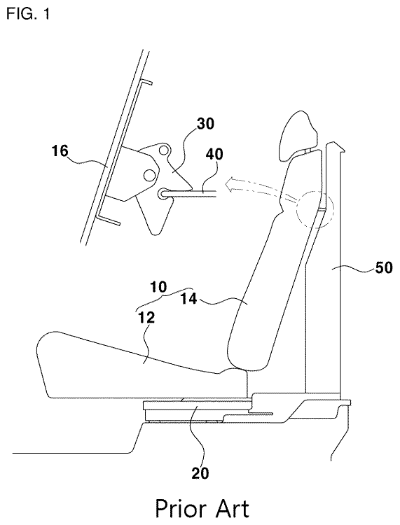

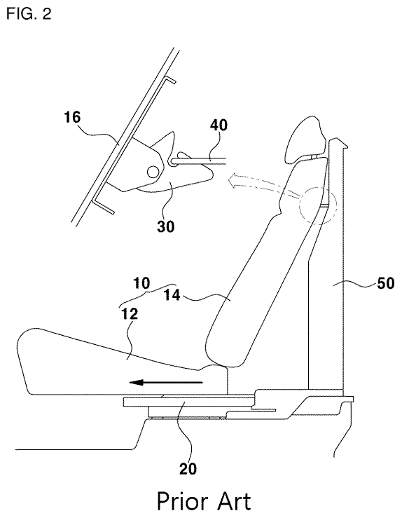

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. Specific structural or functional descriptions given in connection with the embodiments of the present disclosure are merely illustrative for the purpose of describing embodiments according to the concepts of the present disclosure. Thus, the embodiments according to the concepts of the present disclosure may be implemented in various forms. Further, it should be understood that the present description is not intended to limit the disclosure to the illustrated embodiments. On the contrary, the disclosure is intended to cover not only the illustrated embodiments, but also various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described. The same applies to terms such as “include” and “have” and variations thereof.

When a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are described in detail with reference to the accompanying drawings.

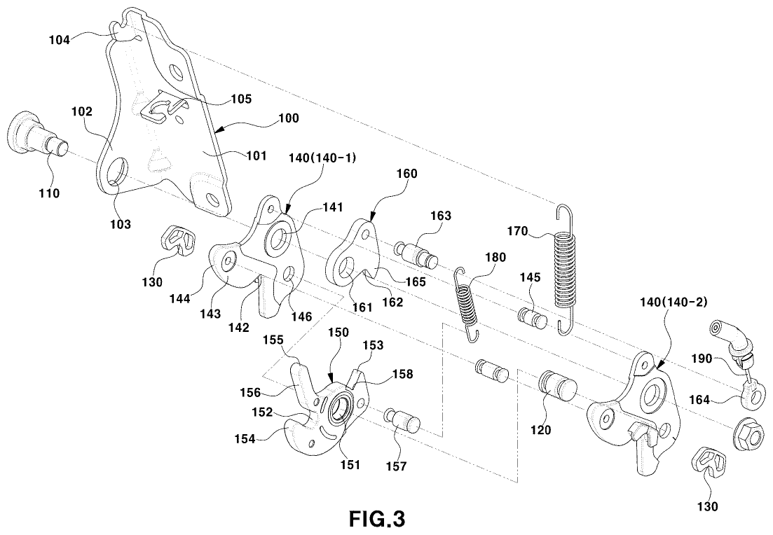

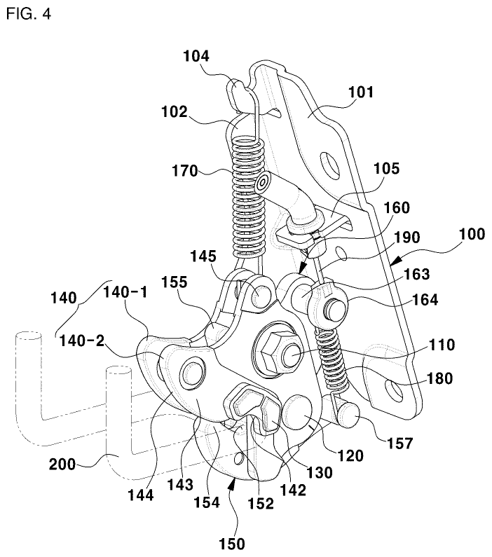

FIG. 3 is an exploded perspective view of a vehicle seatback locking device according to the present disclosure. FIG. 4 is an assembled perspective view of the vehicle seatback locking device according to the present disclosure.

As shown in FIGS. 3 and 4, a base bracket 100 is formed of a mounting plate 101 mounted on a seatback frame 16, which is an internal skeleton of a seatback. A support plate 102 is disposed or formed to be bent from one side of the mounting plate 101. A mounting hole 103 configured for a first rotation shaft 110 to be mounted therein is formed or disposed in the support plate 102.

In addition, a spring fixing end 104 to which the upper end of a first spring 170 is connected is formed or disposed on an upper portion of the mounting plate 101 of the base bracket 100.

In addition, a cable fixing bracket 105 is mounted on a predetermined position of the mounting plate 101 of the base bracket 100 so as to fix a covering material of a cable 190.

According to the present disclosure, an upper latch 140 is rotatably mounted on the base bracket 100 by the first rotation shaft 110.

The upper latch 140 has a first rotation shaft coupling hole 141 formed in the front end thereof and formed or disposed to be aligned with the mounting hole 103 of the support plate 102 in the left-and-right direction. Here, the first rotation shaft 110 in the form of a hinge bolt is inserted into and coupled to the first rotation shaft coupling hole 141 through the mounting hole 103. This arrangement allows the upper latch 140 to be rotatably mounted on the support plate 102 of the base bracket 100 through the first rotation shaft 110.

In one embodiment, the upper latch 140 may be formed of or include a first upper latch 140-1 and a second upper latch 140-2 each having the same shape, which are coupled to each other by riveting or the like with a lower latch 150 interposed therebetween.

In this manner, since the lower latch 150 is in the state of being protected by the first upper latch 140-1 and the second upper latch 140-2, the lower latch 150 may be prevented from being moved by an external force out of the original position thereof.

The upper latch 140 has a concave sub-locking groove 142 provided at the rear end thereof and formed toward the front side. Further, the upper latch 140 has an integral slide end 143 that is integrally formed to protrude from the rear end thereof toward the rear side. The slide end is located at an upper portion of the sub-locking groove 142 and guides insertion of a striker 200 into the sub-locking groove 142 of the upper latch 140 and a main locking groove 152 of the lower latch 150.

In this case, the striker 200 is fixedly mounted on a body panel 50 (i.e., partition panel) configured to partition the vehicle interior into an interior space and a luggage space.

In one embodiment, a rear portion of the slide end 143 is formed to have or includes a first inclined surface 144 formed to slidably contact the striker 200. The first inclined surface 144 is formed or disposed to be inclined downward from a rear portion thereof toward the front side of the vehicle.

Accordingly, the striker 200 may be guided toward the sub-locking groove 142 of the upper latch 140 and the main locking groove 152 of the lower latch 150 while slidably contacting the first inclined surface 144 of the slide end 143.

In this case, a rubber damper 130 is mounted on the inner surface of the sub-locking groove 142 of the upper latch 140. The rubber damper 130 reduces impact on the sub-locking groove 142 when the striker 200 is inserted into the sub-locking groove 142.

The first spring 170 connects the base bracket 100 to the upper latch 140 in a tensile manner.

An upper portion of the first spring 170 is fixed to the spring fixing end 104 formed or disposed on an upper portion of the mounting plate 101 of the base bracket 100. A lower portion of the first spring 170 is connected to a fixing pin 145 mounted in an upper portion of the upper latch 140.

Accordingly, the first spring 170 is tensioned when the upper latch 140 is rotated in the locking direction to lock the striker 200 and then provides elastic restoring force to the upper latch 140 so as to allow the upper latch to be rotated in the unlocking direction.

According to the present disclosure, the lower latch 150 has the main locking groove 152 formed or disposed in a rear portion thereof. Further, the lower latch 150 has a first locking groove 158 and a first locking protrusion 153 respectively provided in and on the front ends thereof and formed or disposed to be adjacent to each other in the forward-and-rearward direction. The first locking groove and the first locking protrusion are locked and coupled to a cam 160 on the front part.

Here, the first locking groove 158 formed or disposed in the front end of the lower latch 150 is formed to be concave downward. The locking protrusion 153 is formed or disposed to protrude upward.

In addition, the lower latch 150 has a hook portion 154 formed to protrude from the rear end thereof and located at the rear side of the main locking groove 152, in which the hook portion limits the depth of the main locking groove 152.

Further, the lower latch 150 has a slide pin 155 integrally formed at the upper portion of the rear end thereof, i.e., located on the front side of the main locking groove 152. The slide pin has a predetermined length and guides the striker 200 to the main locking groove 152.

In one embodiment, the rear end of the slide pin 155 is formed to have a second inclined surface 156 slidably contacting the striker 200. The second inclined surface 156 is formed to be inclined downward from the rear side toward the front side.

Accordingly, the striker 200 may be guided toward the main locking groove 152 of the lower latch 150 by slidably contacting the second inclined surface 156 of the slide pin 155.

The lower latch 150 provided as described above is rotatably mounted on the upper latch 140 through a second rotation shaft 120.

A second rotation shaft coupling hole 146 is formed in the lower end of the upper latch 140 and a second rotation shaft coupling hole 151 is also formed at a position between the main locking groove 152 and the locking protrusion 153 of the lower latch 150. Here, the second rotation shaft 120 is in the form of a hinge rivet and is inserted into and coupled to the second rotation shaft coupling hole 151 of the lower latch 150 through the second rotation shaft coupling hole 146 of the upper latch 140, thereby entering a state in which the lower latch 150 is rotatably mounted on the upper latch 140 through the second rotation shaft 120.

According to the present disclosure, the cam 160 is rotatably mounted on the first rotation shaft 110.

The cam 160 has a first rotation shaft coupling hole 161 formed or disposed in the rear end thereof and formed or disposed to be aligned with the first rotation shaft coupling hole 141 formed in the front end of the upper latch 140. Further, the first rotation shaft 110 is in the form of a hinge bolt and is inserted into the first rotation shaft coupling hole 141 of the upper latch 140 through the mounting hole 103 formed in the support plate 102 of the base bracket 100. The first rotation shaft 110 is further inserted into and coupled to the first rotation shaft coupling hole 161 of the cam 160, thereby entering a state in which the cam 160 is rotatably mounted on the first rotation shaft 110.

Here, the cam 160 is rotatably arranged between the first upper latch 140-1 and the second upper latch 140-2, which are coupled to each other. This arrangement makes it possible to prevent the cam 160 from being moved out of the original position thereof due to external force in a state in which the cam is protected by the first upper latch 140-1 and the second upper latch 140-2.

The cam 160 has a second locking groove 162 and a second locking protrusion 165 respectively provided in and on the lower front ends thereof and formed to be adjacent to each other in the forward-and-rearward direction.

In other words, the cam 160 has the second locking groove 162 formed or disposed in the lower front end thereof and configured to allow the first locking protrusion 153 of the lower latch 150 to be detachably inserted thereinto, and has the second locking protrusion 165 formed on the lower front end thereof and detachably inserted into the first locking groove 158 of the lower latch 150.

In this case, the second locking groove 162 of the cam 160 is formed to be concave upward, and the second locking protrusion 165 is formed to protrude downward.

A second spring 180 connects the lower latch 150 to the cam 160 in a tensile manner.

The cam 160 has a first fixing pin 163 mounted in the upper end thereof and configured to allow the upper end of the second spring 180 to be connected thereto. The lower latch 150 has a second fixing pin 157 mounted in the lower end thereof and configured to allow the second spring 180 to be connected thereto.

In addition, a cable holder 164 is mounted on the first fixing pin 163 mounted on the upper end of the cam 160. The end of the cable 190 is connected to the cable holder 164 in a pullable manner. In this way, when a user tilts a lever (not shown), the cable 190 may be pulled. Simultaneously, the cam 160 may be rotated in the unlocking direction.

Accordingly, in a state in which the striker 200 is locked and inserted into the sub-locking groove 142 of the upper latch 140 and the main locking groove 152 of the lower latch 150, when the cam 160 is rotated in the unlocking direction by pulling operation of the cable 190, the second spring 180 is tensioned. Simultaneously, the second locking protrusion 165 of the cam 160 is separated from the first locking groove 158 of the lower latch 150. Thereafter, the lower latch 150 is also rotated by elastic restoring force of the second spring 180 in the unlocking direction and the first locking protrusion 153 of the lower latch 150 is locked and inserted into the second locking groove 162 of the cam 160.

On the other hand, in a state in which the striker 200 is separated from the sub-locking groove 142 of the upper latch 140 and the main locking groove 152 of the lower latch 150, when the striker 200 is again inserted into the sub-locking groove 142 of the upper latch 140 and the main locking groove 152 of the lower latch 150, the lower latch 150 is rotated in the locking direction by force of the striker 200 pushing the slide pin 155 of the lower latch 150. At this time, the second spring 180 is tensioned. Simultaneously, the first locking protrusion 153 of the lower latch 150 is separated from the second locking groove 162 of the cam 160. Thereafter, the cam 160 is also rotated by elastic restoring force of the second spring 180 in the locking direction. The second locking protrusion 165 of the cam 160 is locked and inserted into the first locking groove 158 of the lower latch 150.

Hereinafter, a description is given as to an operation flow of the seatback locking device of the present disclosure having the above-described configuration.

### Unlocking Operation of Locking Device at Position Before Forward Sliding Movement of Seat

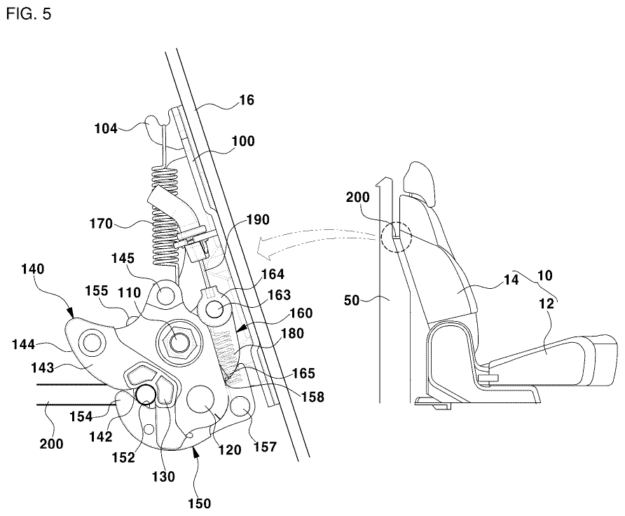

FIG. 5 is a side cross-sectional view of the mounting state of the vehicle seatback locking device according to the present disclosure. The side cross-sectional view shows a locking arrangement state of the vehicle seatback locking device at a position before forward sliding movement of a seat.

As shown in FIG. 5, in a state in which forward sliding movement of the seat is not performed, i.e., a seat cushion 12 and a seatback 14 of a rear seat 10 are arranged at the rearmost position, the striker 200 mounted on the body panel 50 is inserted and locked into the sub-locking groove 142 of the upper latch 140 and the main locking groove 152 of the lower latch 150. This enables the seatback 14 to maintain the fixed state thereof.

At this time, the upper latch 140 is maintained in a state of being rotated rearward by a predetermined angle around the first rotation shaft 110 while being pushed by the striker 200. Also, the first spring 170 is maintained in a tensioned state.

In addition, the second locking protrusion 165 of the cam 160 is in a state of being constantly inserted into the first locking groove 158 of the lower latch 150. This enables the lower latch 150 to maintain the fixed state thereof at the locked position.

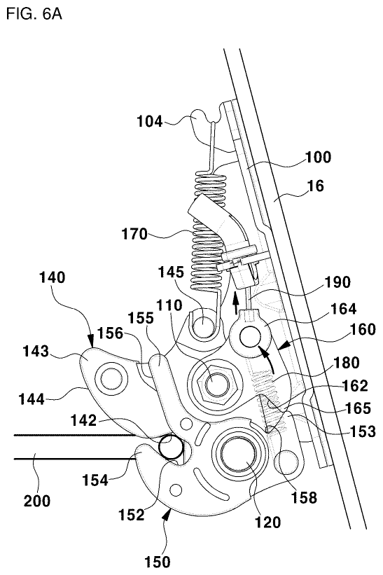

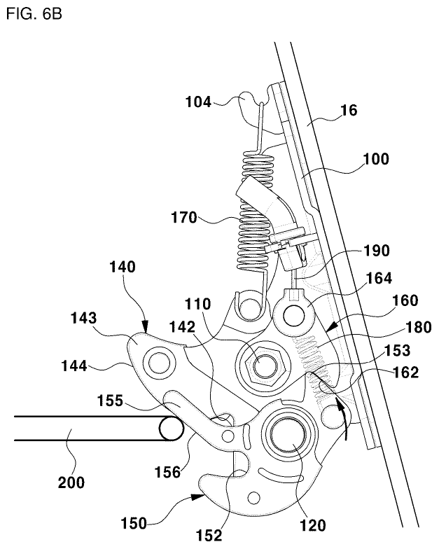

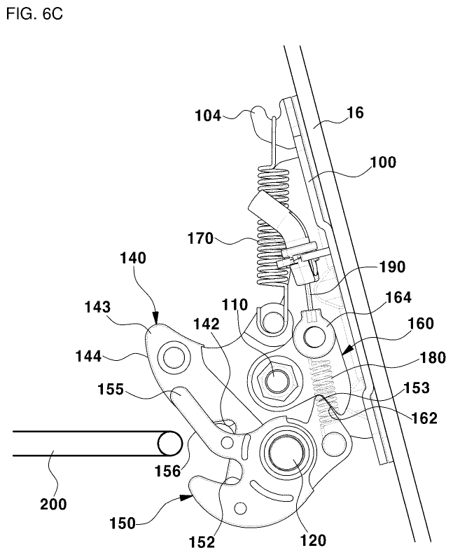

FIGS. 6A-6C are side cross-sectional views of the vehicle seatback locking device according to the present disclosure. The side cross-sectional views sequentially show the operation of unlocking the vehicle seatback locking device from a locked state of the vehicle seatback locking device at the position before forward sliding movement of the seat.

First, in a state in which the striker 200 is locked and inserted into the sub-locking groove 142 of the upper latch 140 and the main locking groove 152 of the lower latch 150, as shown in FIG. 6A, when the cam 160 is rotated in the unlocking direction around the first rotation shaft 110 by pulling operation of the cable 190 according to the user's operation of pulling the lever (not shown) rearwards, the second spring 180 is tensioned. Simultaneously, the second locking protrusion 165 of the cam 160 is separated from the first locking groove 158 of the lower latch 150.

Then, when the lower latch 150 is pulled in the unlocking direction by elastic restoring force of the second spring 180, as shown in FIG. 6B, the lower latch 150 is rotated in the unlocking direction around the second rotation shaft 120. Also, the first locking protrusion 153 of the lower latch 150 is locked and inserted into the second locking groove 162 of the cam 160.

Accordingly, when the lower latch 150 is rotated in the unlocking direction, the main locking groove 152 of the lower latch 150 is located at an open position allowing the striker 200 to be separated from the main locking groove 152, as shown in FIG. 6C. In this manner, the striker 200 may be separated from the sub-locking groove 142 of the upper latch 140 and the main locking groove 152 of the lower latch 150, thereby enabling the seatback 14 to be folded over the seat cushion 12.

Here, when the striker 200 is separated from the sub-locking groove 142 of the upper latch 140 and the main locking groove 152 of the lower latch 150, pushing force of the striker 200 toward the upper latch 140 is released. Accordingly, the upper latch 140 is rotated forward by elastic restoring force of the first spring 170 and is located at a neutral position (a position at which elastic restoring force of the first spring does not act).

### Locking Operation of Locking Device at Position Before Forward Sliding Movement of Seat

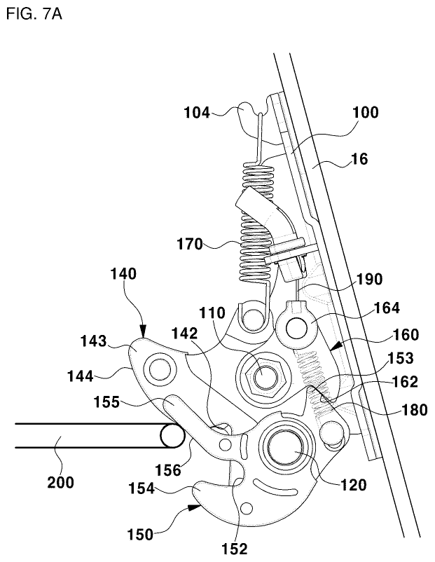

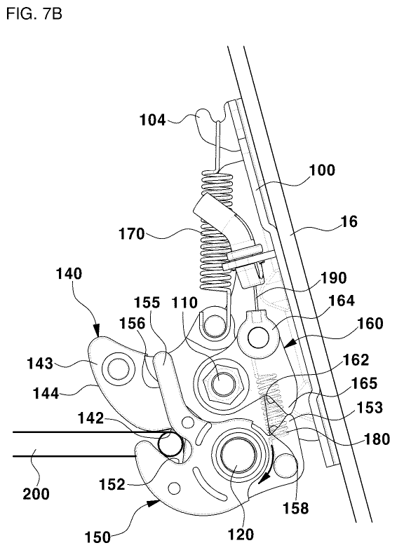

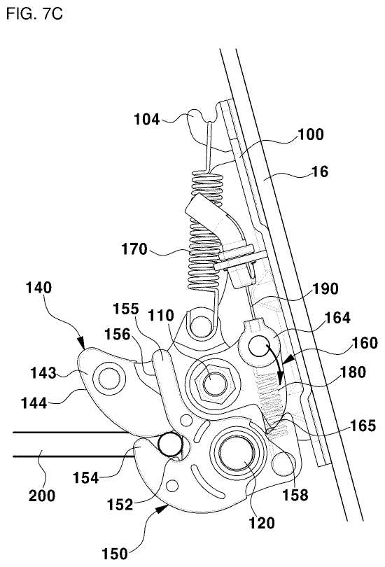

FIGS. 7A-7C are side cross-sectional views of the vehicle seatback locking device according to the present disclosure. The side cross-sectional views sequentially show the operation of locking the vehicle seatback locking device from the unlocked state of the vehicle seatback locking device at the position before forward sliding movement of the seat.

When the seatback 14 is folded and then is unfolded again at the position before forward sliding movement of the rear seat, i.e., the seat cushion 12 and the seatback 14 of the rear seat 10 are arranged at the rearmost position, as shown in FIG. 7A, the striker 200 slidably contacts the second inclined surface 156 of the slide pin 155 of the lower latch 150. The striker 200 then is guided to the sub-locking groove 142 of the upper latch 140 and the main locking groove 152 of the lower latch 150.

In this case, when the striker 200 slidably contacts the second inclined surface 156 of the slide pin 155 of the lower latch 150, as shown in FIG. 7B, the lower latch 150 is pushed by the striker 200 and then is rotated in the locking direction around the second rotation shaft 120. Accordingly, the second spring 180 is tensioned and the first locking protrusion 153 of the lower latch 150 is separated from the second locking groove 162 of the cam 160.

Then, when the cam 160 is pulled in the locking direction by elastic restoring force of the second spring 180, as shown in FIG. 7C, the cam 160 is also rotated in the locking direction around the first rotation shaft 110. This causes the second locking protrusion 165 of the cam 160 to be locked and inserted into the first locking groove 158 of the lower latch 150.

Here, the upper latch 140 is pushed by the striker 200 and is rotated in the locking direction. Simultaneously, the first spring 170 is tensioned.

Accordingly, when the second locking protrusion 165 of the cam 160 is locked and inserted into the first locking groove 158 of the lower latch 150, as shown in FIG. 7C, the lower latch 150 may be maintained in a state of being firmly fixed at the locked position thereof. The striker 200 may be maintained in a state of being locked and inserted into the sub-locking groove 142 of the upper latch 140 and the main locking groove 152 of the lower latch 150.

In this manner, when the seatback 14 is folded at the position before forward sliding movement of the rear seat and then the seatback 14 is unfolded again, the striker 200 mounted on the body panel 50 is inserted and locked into the sub-locking groove 142 of the upper latch 140 and the main locking groove 152 of the lower latch 150. Accordingly, the seatback 14 may maintain the fixed state thereof through locking between the striker and the upper and lower latches.

### Unlocking Operation of Locking Device at Position After Forward Sliding Movement of Seat

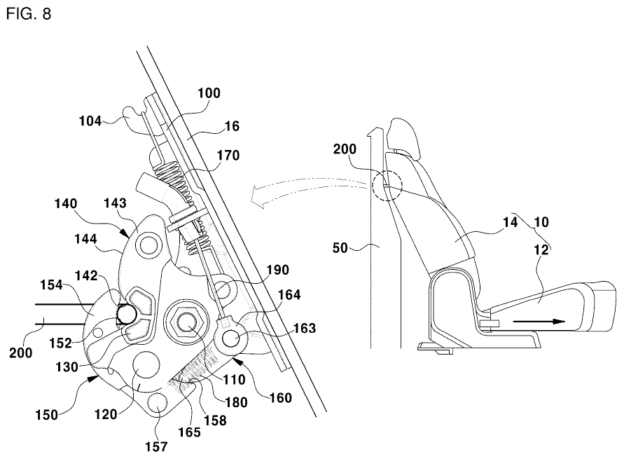

FIG. 8 is a side cross-sectional view showing the seatback mounting state of the vehicle seatback locking device according to the present disclosure. The side cross-sectional view shows the locking arrangement state of the vehicle seatback locking device at a position after forward sliding movement of the seat.

As shown in FIG. 8, when the seat cushion 12 of the rear seat 10 slides forward along the rail 20, the seatback 14 connected to the seat cushion 12 is reclined by a predetermined angle. This implements a relaxation/comfort mode to enable an occupant to take a relaxed, comfortable posture.

After the seat is slidably moved forward, i.e., when the seat cushion 12 and the seatback 14 of the rear seat 10 are arranged at the forwardmost position, the striker 200 mounted on the body panel 50 is locked and inserted into the sub-locking groove 142 of the upper latch 140 and the main locking groove 152 of the lower latch 150. This arrangement maintains the locked state of the seatback 14.

Here, even if the seatback 14 is reclined rearward by a predetermined angle, the upper latch 140 is pushed by the striker 200 and is maintained in a state of being rotated forward by a predetermined angle around the first rotation shaft 110. The first spring 170 is also maintained in a tensioned state.

Furthermore, when the upper latch 140 is rotated forward by rearward reclining of the seatback 14, the coaxially connected cam 160 is also rotated in the same direction. Here, when the cam 160 is rotated, the cam pushes the lower latch 150 such that the lower latch is also rotated in the same direction. In this manner, as shown in FIG. 8, the striker 200 may be maintained in a state of being locked and inserted into the sub-locking groove 142 of the upper latch 140 and the main locking groove 152 of the lower latch 150. Accordingly, the seatback 14 may maintain the fixed state thereof through locking between the striker and the upper and lower latches.

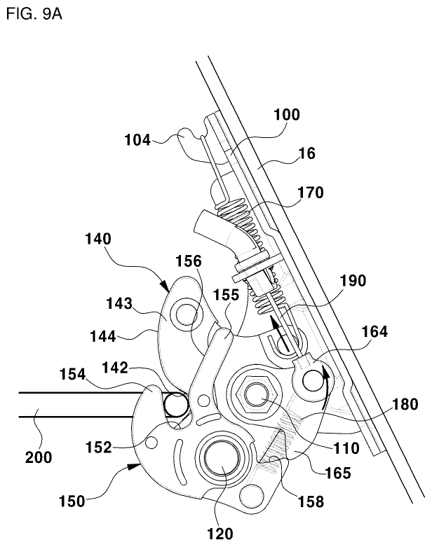

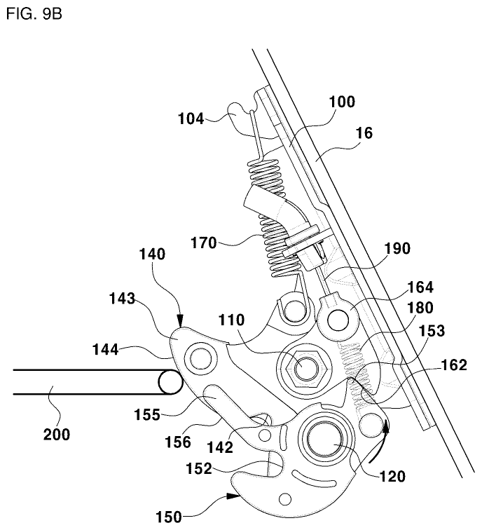

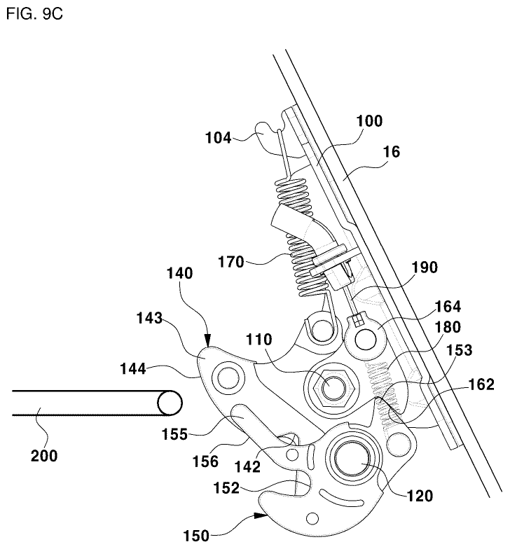

FIGS. 9A-9C are side cross-sectional views of the vehicle seatback locking device according to the present disclosure. The side cross-sectional views sequentially show the operation of unlocking the vehicle seatback locking device from the locked state of the vehicle seatback locking device at the position after forward sliding movement of the seat.

First, in a state in which the striker 200 is locked and inserted into the sub-locking groove 142 of the upper latch 140 and the main locking groove 152 of the lower latch 150, as shown in FIG. 9A, when the cam 160 is rotated in the unlocking direction around the first rotation shaft 110 by pulling operation of the cable 190 according to the user's operation of pulling the lever (not shown) rearwards, the second spring 180 is tensioned. Simultaneously, the second locking protrusion 165 of the cam 160 is separated from the first locking groove 158 of the lower latch 150.

Then, when the lower latch 150 is pulled in the unlocking direction by elastic restoring force of the second spring 180, as shown in FIG. 9B, the lower latch 150 is rotated in the unlocking direction around the second rotation shaft 120. Also, the first locking protrusion 153 of the lower latch 150 is locked and inserted into the second locking groove 162 of the cam 160.

Accordingly, when the lower latch 150 is rotated in the unlocking direction, as shown in FIG. 9C, the main locking groove 152 of the lower latch 150 is placed at an open position allowing the striker 200 to be separated from the main locking groove 152. In this manner, the striker 200 may be separated from the sub-locking groove 142 of the upper latch 140 and the main locking groove 152 of the lower latch 150. This enables the seatback 14 to be folded over the seat cushion 12.

Here, when the striker 200 is separated from the sub-locking groove 142 of the upper latch 140 and the main locking groove 152 of the lower latch 150, pushing force of the striker 200 toward the upper latch 140 is released. Accordingly, the upper latch 140 is rotated rearward by elastic restoring force of the first spring 170 and is located at a neutral position (a position at which elastic restoring force of the first spring does not act).

### Locking Operation of Locking Device at Position After Forward Sliding Movement of Seat

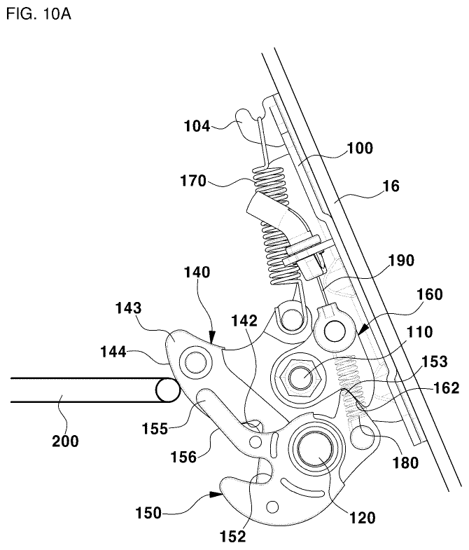

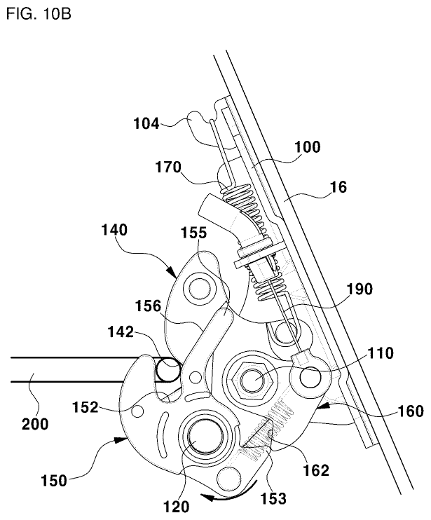

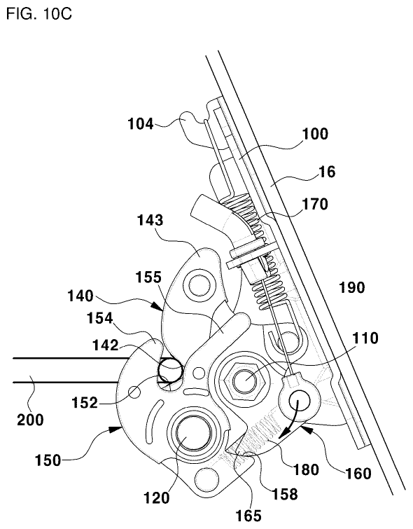

FIGS. 10A-10C are side cross-sectional views of the vehicle seatback locking device according to the present disclosure. The side cross-sectional views sequentially show the operation of locking the vehicle seatback locking device from the unlocked state of the vehicle seatback locking device at the position after forward sliding movement of the seat.

When the seatback 14 is folded at the position after forward sliding movement of the rear seat and then the seatback 14 is unfolded again, as shown in FIG. 10A, the striker 200 slidably contacts the first inclined surface 144 of the slide end 143 of the upper latch 140 and is guided to the sub-locking groove 142 of the upper latch 140 and the main locking groove 152 of the lower latch 150.

Here, the striker 200 slidably contacts the first inclined surface 144 of the slide end 143 of the upper latch 140 and then continuously slidably contacts the second inclined surface 156 of the slide pin 155 of the lower latch 150.

Subsequently, as shown in FIG. 10B, the upper latch 140 is pushed by the striker 200 and is rotated in the locking direction around the first rotation shaft 110. Simultaneously, the lower latch 150 is pushed by the striker 200 and is rotated in the locking direction around the second rotation shaft 120. In this manner, the first spring 170 and the second spring 180 are tensioned. Simultaneously, the first locking protrusion 153 of the lower latch 150 is separated from the second locking groove 162 of the cam 160.

Then, when the cam 160 is pulled in the locking direction by elastic restoring force of the second spring 180, as shown in FIG. 10C, the cam 160 is also rotated in the locking direction around the first rotation shaft 110. Accordingly, the second locking protrusion 165 of the cam 160 is locked and inserted into the first locking groove 158 of the lower latch 150.

Here, when the second locking protrusion 165 of the cam 160 is locked and inserted into the first locking groove 158 of the lower latch 150, as shown in FIG. 10C, the lower latch 150 may maintain a firmly fixed state thereof at a position where the lower latch locks the striker 200. The striker 200 may be maintained in a state of being locked and inserted into the sub-locking groove 142 of the upper latch 140 and the main locking groove 152 of the lower latch 150.

In this case, when the upper latch 140 is further rotated by a predetermined angle in the locking direction by pushing force of the striker 200, the cam 16 and the lower latch 150 are also further rotated by the same angle in the locking direction. Accordingly, as shown in FIG. 10C, the hook portion 154 of the lower latch 150 is located at a position preventing the striker 200 inserted into the sub-locking groove 142 of the upper latch 140 and the main locking groove 152 of the lower latch 150 from being separated therefrom. This arrangement makes it possible to more reliably lock the striker.

More specifically, when the upper latch 140 is pushed further by the striker 200, the upper latch is further rotated forward in the locking direction by a predetermined angle around the first rotation shaft 110. Simultaneously, the cam 160 is also further rotated forward in the locking direction at the same predetermined angle around the first rotation shaft 110. Here, the lower latch 150 is also further rotated forward in the locking direction at the same predetermined angle, thereby entering a state shown in FIG. 10C. In this state, the hook portion 154 of the lower latch 150 prevents the striker 200 inserted into the sub-locking groove 142 of the upper latch 140 and the main locking groove 152 of the lower latch 150 from being separated therefrom.

In this manner, when the seatback 14 is folded at the position after forward sliding movement of the rear seat and then the seatback 14 is unfolded again, the striker 200 mounted on the body panel 50 is inserted and locked into the sub-locking groove 142 of the upper latch 140 and the main locking groove 152 of the lower latch 150 and locked. This arrangement maintains the fixed state of the seatback 14.

As described above, the striker 200 is first locked by the upper latch 140 and the lower latch 150. The lower latch 150 is secondarily locked by the cam 160. This makes it possible not only to prevent the striker 200 from being separated from the lower latch 150 due to external force, but also to prevent unexpected unlocking of the seatback.

As should be apparent from the above description, the present disclosure provides the following effects.

First, a striker is first locked by an upper latch and a lower latch. The lower latch is secondarily locked by a cam. This provides a latch device having a reliable structure capable of fundamentally preventing the lower latch from being rotated in the unlocking direction due to external force.

Second, it is possible not only to prevent the striker from being separated from the lower latch by fundamentally preventing the lower latch from being rotated in the unlocking direction due to external force, but also to prevent unexpected unlocking of a seatback. Accordingly, it is possible to prevent the seatback from unexpectedly deviating from the unfolded position in the event of vehicle collision, thereby preventing injury to an occupant caused by unexpected movement of the seatback.

Third, slide ends are respectively formed on the upper latch and the lower latch such that the striker is smoothly guided to the locking position, thereby enabling the upper latch and the lower latch to easily lock the striker.

Fourth, the striker is easily separated from the upper latch and the lower latch through an operation in which the lower latch is rotated to the unlocking position when the striker is unlocked from the lower latch and through an operation in which the lower latch is fixed to the unlocking position by the cam. Accordingly, the striker may be easily unlocked from the upper latch and the lower latch.

Fifth, even if the seatback is reclined, the locked state of the striker may be continuously maintained by allowing the upper latch, the lower latch, and the cam to be rotated together. Accordingly, the seatback may continuously maintain the fixed state thereof in a state of being unfolded.

The technical concepts of the present disclosure have been described in detail with reference to various embodiments. However, it should be appreciated by those of ordinary skill in the art that various modifications and improvements may be made in these embodiments without departing from the principles and spirit of the disclosure, the scope of which is defined in the appended claims and equivalents thereto.

What is claimed is:

1. A vehicle seatback locking device comprising:
a seatback frame;
a base bracket mounted on the seatback frame;
an upper latch having a sub-locking groove in a rear portion thereof, the upper latch rotatably mounted on the base bracket by a first rotation shaft;
a first spring connecting the base bracket to the upper latch in a tensile manner;
a lower latch having a main locking groove in a rear portion thereof, the lower latch rotatably mounted on the upper latch by a second rotation shaft;
a cam rotatably mounted on the first rotation shaft;
a cable connected to an upper portion of the cam in a pullable manner;
a second spring connecting the lower latch to the cam in a tensile manner; and
a striker fixedly mounted on a body panel, the striker detachably locked and inserted into the sub-locking groove of the upper latch and the main locking groove of the lower latch.

2. The vehicle seatback locking device of claim 1, wherein the lower latch has a first locking groove in a front end thereof and a first locking protrusion on the front end thereof, wherein the cam has a second locking groove in a lower portion thereof and a second locking protrusion on the lower portion thereof, wherein the first locking protrusion is detachably inserted into the second locking groove, and wherein the second locking protrusion is detachably inserted into the first locking groove.

3. The vehicle seatback locking device of claim 1, wherein the upper latch has a first rotation shaft coupling hole in a front end thereof, wherein the cam has another first rotation shaft coupling hole in a rear end thereof, and wherein the first rotation shaft is inserted into and coupled to the respective first rotation shaft coupling hole and other first rotation shaft coupling hole.

4. The vehicle seatback locking device of claim 1, wherein the upper latch includes a first upper latch and a second upper latch each having an identical shape, and wherein the first upper latch and the second upper latch are coupled to each other with the lower latch interposed therebetween.

5. The vehicle seatback locking device of claim 1, wherein the upper latch has an integral slide end protruding from a rear end thereof, and wherein the slide end has a first inclined surface disposed at a rear portion thereof and configured to slidably contact the striker such that the striker is guided to and inserted into the sub-locking groove and the main locking groove.

6. The vehicle seatback locking device of claim 1, wherein the sub-locking groove of the upper latch has a rubber damper mounted thereon, and wherein the rubber damper is configured to reduce impact generated when the striker is inserted into the sub-locking groove.

7. The vehicle seatback locking device of claim 1, wherein the base bracket has a spring fixing end on an upper portion thereof, wherein the spring fixing end is connected to an upper end of the first spring, wherein the upper latch has a fixing pin mounted in an upper end thereof, and wherein the fixing pin is connected to a lower end of the first spring.

8. The vehicle seatback locking device of claim 1, wherein the upper latch has a second rotation shaft coupling hole formed in a lower end thereof, wherein the lower latch has another second rotation shaft coupling hole formed therein and located at a position between the main locking groove and the locking protrusion, and wherein the second rotation shaft is inserted into and coupled to the respective second rotation shaft coupling hole and other second rotation shaft coupling hole.

9. The vehicle seatback locking device of claim 1, wherein the lower latch has a hook portion protruding upward from a rear end thereof and located at a rear side of the main locking groove, and wherein the hook portion is configured to prevent the striker from being separated from the lower latch.

10. The vehicle seatback locking device of claim 1, wherein the lower latch has an integral slide pin at an upper portion of a rear end thereof, and wherein the slide pin has a second inclined surface disposed on a rear portion thereof and configured to slidably contact the striker such that the striker is guided to and inserted into the main locking groove.

11. The vehicle seatback locking device of claim 2, wherein, in a state in which the striker is locked and inserted into the sub-locking groove of the upper latch and the main locking groove of the lower latch, when the cam is rotated in an unlocking direction by a pulling operation of the cable, the second spring is tensioned, and wherein, simultaneously, the second locking protrusion of the cam is separated from the first locking groove of the lower latch, and then the lower latch is rotated in the unlocking direction by elastic restoring force of the second spring such that the first locking protrusion of the lower latch is locked and inserted into the second locking groove of the cam.

12. The vehicle seatback locking device of claim 11, wherein the lower latch is rotated in the unlocking direction by the elastic restoring force of the second spring such that the main locking groove of the lower latch is located at an open position allowing the striker to be separated from the main locking groove.

13. The vehicle seatback locking device of claim 2, wherein, in a state in which the seatback is folded such that the striker is separated from the sub-locking groove of the upper latch and the main locking groove of the lower latch, when the seatback is unfolded again, the striker is guided to the sub-locking groove and the main locking groove while slidably contacting a slide pin on the lower latch.

14. The vehicle seatback locking device of claim 13, wherein, when the striker is guided by the slide pin of the lower latch so as to be inserted into the main locking groove such that the lower latch is rotated in a locking direction by a force pushing the slide pin of the lower latch, the second spring is tensioned, and wherein, simultaneously, the first locking protrusion of the lower latch is separated from the second locking groove of the cam, and then the cam is rotated in the locking direction by the elastic restoring force of the second spring such that the second locking protrusion of the cam is locked and inserted into the first locking groove of the lower latch.

15. The vehicle seatback locking device of claim 13, wherein, in a state in which the rear seat is slidably moved forwards and then the seatback is folded such that the striker is separated from the sub-locking groove of the upper latch and the main locking groove of the lower latch, when the seatback is unfolded again, the striker is guided to the sub-locking groove and the main locking groove while sequentially slidably contacting a slide end on the upper latch and the slide pin on the lower latch.

16. The vehicle seatback locking device of claim 15, wherein, in a state in which the seatback is reclined by forward sliding movement of the rear seat such that the striker is located higher than the upper latch and the lower latch, when the seatback is unfolded again, the slide end on the upper latch and the slide pin on the lower latch are sequentially pushed by the striker and are rotated forward by a predetermined angle.

17. The vehicle seatback locking device of claim 15, wherein, when the striker is guided by the slide end of the upper latch so as to be inserted into the main locking groove such that the lower latch is rotated in a locking direction by force pushing the slide pin of the lower latch, the second spring is tensioned, and wherein, simultaneously, the first locking protrusion of the lower latch is separated from the second locking groove of the cam, and then the cam is rotated in the locking direction by elastic restoring force of the second spring such that the second locking protrusion of the cam is locked and inserted into the first locking groove of the lower latch.

18. The vehicle seatback locking device of claim 17, wherein the upper latch is further rotated by a predetermined angle in the locking direction by a pushing force of the striker, and wherein, simultaneously, the cam and the lower latch are also further rotated by the predetermined angle in the locking direction, thereby allowing a hook portion of the lower latch to be located at a position preventing separation of the striker inserted into the sub-locking groove of the upper latch and the main locking groove of the lower latch.

19. The vehicle seatback locking device of claim 1, wherein the cam has a first fixing pin mounted in an upper end thereof and can upper end of the second spring is connected thereto, and wherein the lower latch has a second fixing pin mounted in a lower portion of a front end thereof and a lower end of the second spring to be connected thereto.

20. The vehicle seatback locking device of claim 19, wherein the first fixing pin has a cable holder mounted thereon, and wherein the cable is connected to the cable holder in a pullable manner.
